(19) United States
(12) Patent Application Publication
(10) Pub. No.: US 2009/0223056 A1
(43) Pub. Date: Sep. 10, 2009

(54) Dynamo-powered shaver

(76) Inventors: Troy D. Wilson, Minden, NV (US); Xingrong Zhang, Shenzhen (CN); Weifu Zhang, Shenzhen (CN)

Correspondence Address: John W. Crosby, 1650 Highway 395, Minden, NV, 89423, US

(21) Appl. No.: 12/284,174

(22) Filed: Sep. 19, 2008

Related U.S. Application Data
(60) Provisional application No. 61/068,490, filed on Mar. 8, 2008.

(51) Int. Cl. B26B 19/00; B26B 19/28; B26B 19/38; B26B 19/20

(52) U.S. Cl. 30/34.1; 30/34.05; 30/45; 30/526; 30/43

(57) ABSTRACT

A power shaver having a hand-cranked dynamo is disclosed. The shaver includes a battery that can be charged by the hand-cranked dynamo, or from an alternating current adaptor that delivers charge from another battery, or from a charger that connects to a conventional source of alternating current. The shaver includes a foldable handle that allows a user to operate the dynamo, and folds against the body of the shaver when not in use. Indication lights located on the body of the shaver provide charging and status information to a user.

### FIELD OF THE INVENTION

The present invention relates broadly to power shavers. Specifically, the present invention relates to shavers powered from multiple power sources. More specifically, the present invention relates to shavers powered by a hand-cranked dynamo.

### BACKGROUND OF THE INVENTION

Portable power shavers have been widely used for decades. Typically, a shaver is powered by an electrical source, either a connection to alternating current or through the use of battery. Battery-powered shavers typically use a charger that connects to the source of alternating current to keep the battery charged and the shaver operable. However, such shavers have relatively limited portability, as a conventional source of electricity is required for existing shavers, and a battery can only maintain a charge for a limited amount of time. For people who camp, travel, enjoy outdoor recreation and sporting events or have adjusted their lifestyles to live separate from public electrical utilities, a power shaver presents a challenge that currently has not been met. Thus, there is a heartfelt need for a power shaver that can maintain a charge apart from a conventional source of electricity.

### SUMMARY OF THE INVENTION

In one aspect, the present invention provides a portable power shaver. The shaver includes a body, an internal rechargeable battery, an electrical circuit, a shaver head having at least one cutting head, and a dynamo having a handle. The dynamo is configured to charge the battery when the handle is cranked in a circular motion. In an embodiment, the body is contoured to receive the handle, and the handle folds against the body when not in use. In an embodiment, the handle includes a gripping knob by which a user cranks the handle and operates the dynamo to charge the battery. In an embodiment, the shaver includes a charge port that delivers to the battery a charge received from a vehicle power socket through the use of an adapter to deliver charge from a remote battery. In an embodiment, the charge port delivers to the battery a charge received from a conventional source of alternating current through the use of an adapter.

In an embodiment, the shaver includes at least one indication light, the indication light providing information to a user. The information may comprise an indication that the battery is currently being charged, or an indication that the battery needs to be charged.

In an embodiment, the at least one indication light includes a light emitting diode. In an embodiment, the indication light changes color or blinks to indicate a change in status.

In an embodiment, the shaver includes a plurality of gripping surfaces located on opposing sides of the shaver body.

In an embodiment, the shaver head comprises a foil head covering at least one cutting head. The foil head may include multiple surfaces separated by a depression. In another embodiment, the shaver head includes one or more rotating cutting heads arranged in a substantially triangular or side by side pattern on a common surface of the shaver head.

In an embodiment, the shaver includes a trimmer. The trimmer can be located proximate to the cutting head, or, in another embodiment, be a retractable trimmer located on the shaver body.

Many other features and advantages of the present invention will be apparent to those skilled in the art from the following detailed description, when considered in conjunction with the drawings, in which:

### BRIEF DESCRIPTION OF THE DRAWINGS

FIGS. 1A-1C illustrate the body of a shaver in accordance with the present invention.

FIGS. 2A-2B illustrate a preferred embodiment of the head of the shaver in accordance with the present invention.

FIG. 3 illustrates an exploded view of the shaver in accordance with the present invention.

FIG. 4 illustrates another preferred embodiment of the head of the shaver in accordance with the present invention.

FIG. 5 illustrates a vehicle adapter that can be used with the shaver of the present invention.

FIG. 6 illustrates an AC charging unit that can be used with the shaver of the present invention.

FIG. 7 illustrates in schematic form circuitry that controls the shaver of the present invention during operation.

### DETAILED DESCRIPTION

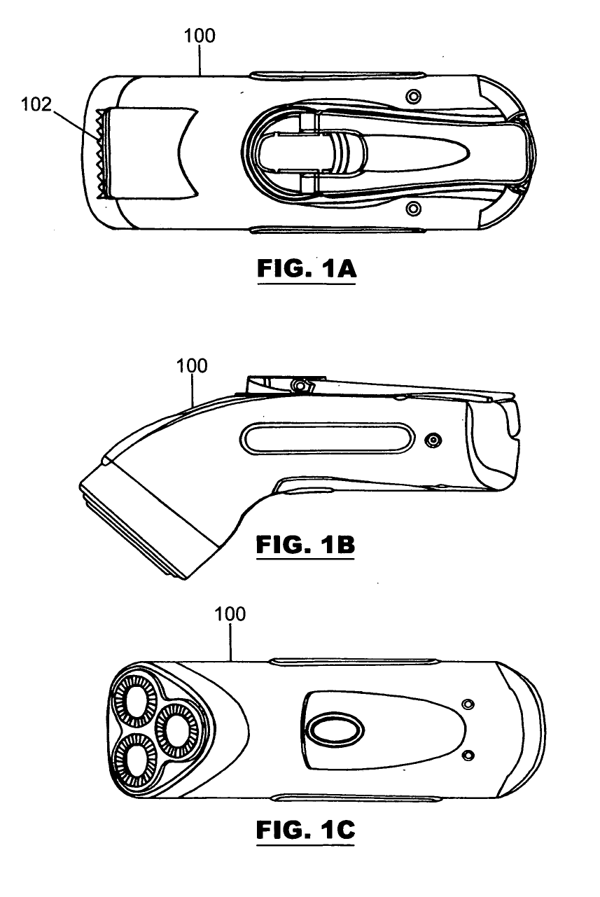

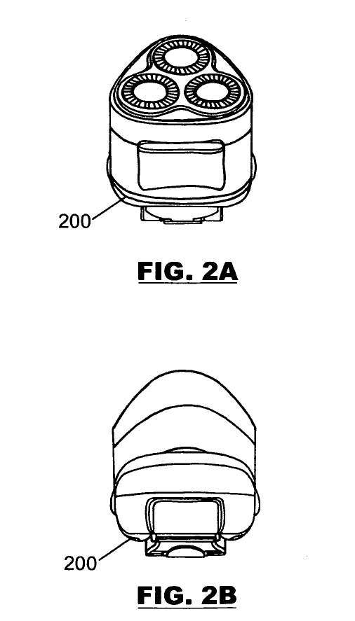

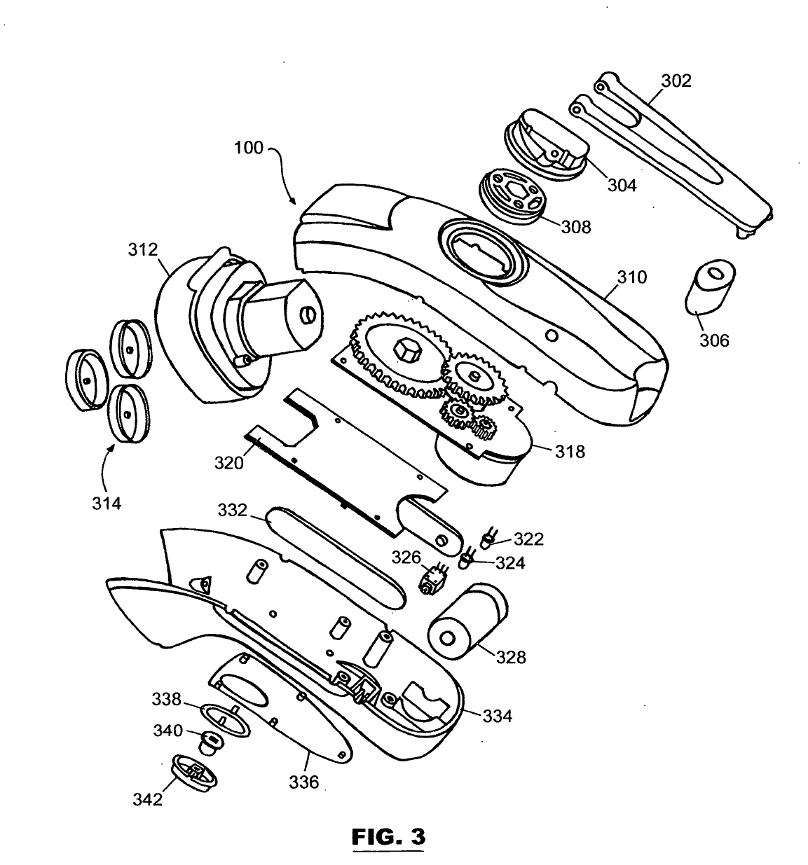

Directing attention to FIGS. 1A-1C, shaver 100 includes in an embodiment trimmer 102. Trimmer 102 can be arranged in a retractable configuration and utilize the same power source that powers shaver head 200 (FIGS. 2A-2B). Shaver 100 employs a hand-cranked dynamo to provide a charging mechanism for an onboard battery that powers shaver 100.

Directing attention to FIG. 3, shaver 100 includes folding handle 302 that remains close to the body of shaver 100 during operation, but can be rotated on a hinged connection to receiver 304 to expose finger grip 306, which can be grasped by the user to rotate folding handle 302 in a circular motion. When rotated, receiver 304 and adaptor 308, which are placed inside top body plate 310, engage dynamo 318. The principle of operation of a dynamo is well-known to those skilled in the art, and is not explained here as not to obfuscate the present invention. The gear wheels shown on dynamo 318 are spaced apart for clarity; it is to be understood that the gear wheels are all in contact with at least one other gear wheel to facilitate operation of dynamo 318. Shaver head 312, in an embodiment, utilizes a plurality of cutters or heads 314, which, when shaver 100 is operated, cut in a circular motion.

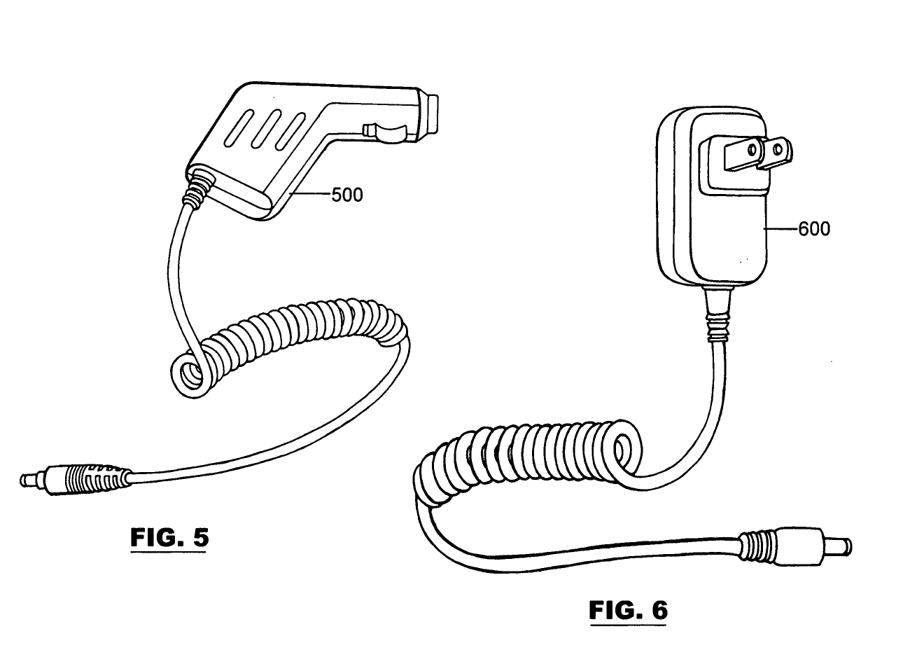

Dynamo 318 fastens to mounting plate 320, which secures dynamo 318 between top body plate 310 and bottom body plate 334. In an embodiment, light emitting diodes (LEDs) 322 and 324 provide information to a user such as an indication that shaver 100 is currently powered on, connected to a charger, is fully charged or needs to be charged. LEDs 322 and 324 can utilize different colors, such as red, green blue, white, or other desired colors, and, in an embodiment, different colors can be used by the same LED to indicate change in charge status, or other information. In an embodiment, LEDs 322 and 324 can flash or blink to impart information to a user. Charging port 326 provides connection between battery 328, either through vehicle adapter 500 (FIG. 5), or charging unit 600 (FIG. 6). Charging port 326 is typically mounted on the side of either top body plate 310 or bottom body plate 334 to provide connection to an external power source.

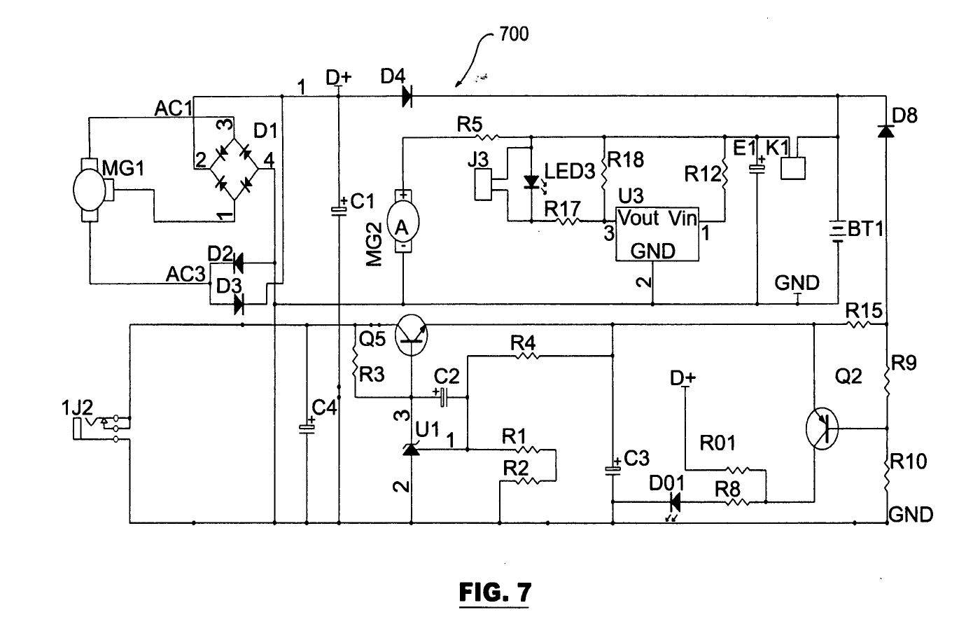

Mounting plate 320 includes a printed circuit board on its bottom side that controls operation of shaver 100, and coordinates charging operations to battery 328. The circuitry of mounting plate 320's printed circuit board is illustrated in detail in FIG. 7. When battery 328 is charged by cranking dynamo 318, the user is able to operate shaver 100 for approximately two minutes.

Side grips 330 and 332 are provided on opposite sides of shaver 100 to provide a comfortable gripping surface by which the user holds shaver 100. Affixed to bottom body plate 334 is front plate 336, which utilizes receiver ring 338, power switch 340, and switchplate 342. The user depresses power switch 340 to power on shaver 100 as well as power off shaver 100.

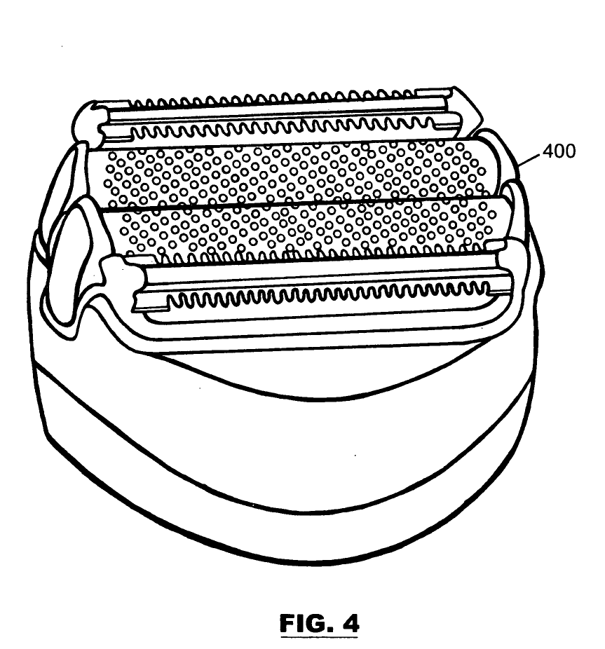

FIG. 4 illustrates an alternative shaver head 400 that can be substituted for the shaver head shown in FIGS. 1-3. Shaver head 400 has a foil head configuration, with trimming teeth located on multiple areas of shaver head 400. Shaver head may also utilize a dual surface configuration for the foil head, where two foil surfaces are separated by a slight valley. The inventors have discovered this configuration works well shaving sensitive areas on the human body, and is preferred by many users. Beneath the foil surfaces are rotary blades that are arranged on spinning cylinders (not shown) located beneath the foil surfaces. In an embodiment, a user may remove shaver head 200 and replace it with shaver head 400. This allows a user to shave different areas of the body more comfortably, and also allows two users having different shaving preferences to share shaver 100.

FIG. 5 illustrates vehicle adaptor 500, which allows battery 328 to be charged via charge port 326 from a direct current source, such as an automobile's cigarette lighter receptacle. FIG. 6 illustrates a convention charging unit that connects to a source of alternating current and charges batter 328 via charge port 326. FIG. 7 illustrates in schematic form circuitry 700 that operates shaver 100 and controls LEDs 322 and 324, as well as charge delivered to battery 328.

While the preferred embodiments of the present invention have been described and illustrated in detail, it is to be understood that many modifications can be made to the various embodiments of the present invention, such as adding or removing rotary or foil cutting heads and trimmer assemblies on the shaver, without departing from the spirit thereof.

What is claimed is:

1. A portable power shaver, comprising:
a body;
a battery;
a shaver head having at least one cutting head;
a dynamo having a handle, the dynamo configured to charge the battery when the handle is cranked in a circular motion.

2. The shaver of claim 1, wherein the body is contoured to receive the handle, the handle folding against the body when not in use.

3. The shaver of claim 2, wherein the handle comprises a gripping knob by which a user cranks the handle and operates the dynamo to charge the battery.

4. The shaver of claim 1, further comprising a charge port.

5. The shaver of claim 4, wherein the charge port delivers to the battery a charge received from an alternating current adapter to deliver charge from a remote battery.

6. The shaver of claim 4, wherein the charge port delivers to the battery a charge received from a conventional source of alternating current.

7. The shaver of claim 1, further comprising at least one indication light, the indication light providing information to a user.

8. The shaver of claim 7, wherein the information comprises an indication that the battery is currently being charged.

9. The shaver of claim 7, wherein the information comprises an indication that the battery needs to be charged.

10. The shaver of claim 7, wherein the at least one indication light comprises a light emitting diode.

11. The shaver of claim 7, wherein the indication light changes color to indicate a change in status.

12. The shaver of claim 7, wherein the indication light blinks to impart information to a user.

13. The shaver of claim 1, further comprising a plurality of gripping surfaces located on opposing sides of the shaver body.

14. The shaver of claim 1, wherein the shaver head comprises a foil head covering the at least one cutting head.

15. The shaver of claim 14, wherein the foil head comprises multiple surfaces separated by a depression.

16. The shaver of claim 1, wherein the shaver head comprises multiple cutting heads arranged in a substantially triangular pattern on a common surface of the shaver head.

17. The shaver of claim 1, further comprising a trimmer attachment.

18. The shaver of claim 17, wherein the trimmer attachment is retractable.
